(19) United States
(12) Patent Application Publication
(10) Pub. No.: US 2004/0192354 A1
(43) Pub. Date: Sep. 30, 2004

(54) Image processing server

(76) Inventor: Tetsuya Sawano, Asaka-shi (JP)

Correspondence Address: BIRCH STEWART KOLASCH & BIRCH, PO BOX 747, FALLS CHURCH, VA, 22040-0747, US

(21) Appl. No.: 10/775,221

(22) Filed: Feb. 11, 2004

(30) Foreign Application Priority Data
Mar. 31, 2003 (JP) P2003-094328

(51) Int. Cl. H04N 7/14; H04Q 7/20

(52) U.S. Cl. 455/457; 348/14.01; 348/14.02

(57) ABSTRACT

An image processing server for providing a service to execute processing of image data, has an image processing portion for processing the image data attached to an e-mail received from a cellular phone by utilizing a grid computing that is constructed by a plurality of PCs connected in parallel via a network, and a reward information producing portion for producing reward information to offer a reward to an owner of the PC, which executed the processing of the image data, out of the PCs. Therefore, the image processing server can implement a service to execute processing of image data at a low cost.

### BACKGROUND OF THE INVENTION

1. Field of the Invention

The present invention relates to an image processing server which provides a service to execute the processing of image data.

2. Description of the Related Art

A cellular phone with a camera widely comes into wide use nowadays. A service to produce a high-quality image by executing an image processing for image data such as still picture, motion picture and etc. in the servers.

In the above service, if a large number of users simultaneously transmit image data to the server that executes the image processing, the server may cause a halt as a result of processing high volumes of image data. Since the recent cellular phone with a camera makes it possible to pick up high-quality image and motion picture, an amount of image data is considerable. Therefore, it is anticipated that the above situation is considerably caused.

As the image processing technology to avoid the above situation such as halt, the distributed processing in which a plurality of computers executes the processing of image data to be processed is proposed (for example, see JP-A-10-55434, JP-A-10-276323 and JP-A-2001-331458). According to the technology, the image processing sever can have higher-speed of the image processing rather than the case where the image data are processed by a single server and can respond to high volumes of image data mentioned as above.

JP-A-10-55434,JP-A-10-276323 and JP-A-2001-331458 are known as related art.

However, the above service is performed by utilizing the technologies set forth in JP-A-10-55434, JP-A-10-276323 or JP-A-2001-331458, the service manager side must prepare a plurality of computers. As a result, a sum of the equipment investment needed to carry out the service is increased.

### SUMMARY OF THE INVENTION

The object of the present invention is to provide an image processing server which provides a service to execute the processing of image data at a low cost.

The invention provides an image processing server, which provides a service to execute processing of image data, having: image processing means for processing image data received from a terminal device by utilizing a grid computing; and reward information producing means for producing reward information to give a reward to an owner of a computer, which executes the processing of image data, out of computers that constitute the grid computing.

According to this configuration, since the image data received from the terminal device are processed by utilizing the grid computing system, the necessary facilities for the processing of the image data can be reduced and a working cost of the image processing server can be reduced. Further, since the reward is given to the owner of the computer, in which the processing of the image data was executed, based on the reward information, the owner of the computer can get a return in exchange for the offering of the image data processing resource of the user's own computer.

The invention provides an image processing server, which provides a service to execute processing of image data received from a mobile terminal device, having: identifying means for identifying a computer owned by an owner of a mobile terminal device, based on a database stores first identification information to identify a computer, which is connected to the image processing server through network, for executing the processing of image data in response to an instruction by the image processing server and second identification information to identify a mobile terminal device owned by an owner of the computer in correspondence with each other, and third identification information to identify a mobile terminal device which sends image data; and image processing instructing means for providing the computer identified by the identifying means with an instruction to execute the processing of image data.

According to this configuration, since the computer owned by the user of the mobile terminal device executes the processing of the image data received from the mobile terminal device, the necessary facilities for the processing of the image data can be reduced and a working cost of the image processing server can be reduced. Also, since the image data are not processed by the PC of other person except the owner of the mobile terminal device, the owner of the mobile terminal device can protect the owner's privacy. In addition, in the case that a plurality of computers are connected to the image processing server, such image processing server can easily decide the computer, which executes the processing of the image data, based on the identification information of the mobile terminal device that transmits the image data, and therefore the processing load of the image processing means can be reduced.

Furthermore, the image processing server further has reward information producing means for producing reward information to give a reward to an owner of a computer which executed the processing of image data.

According to this configuration, since the reward is given to the owner of the computer, which executed the processing of the image data, based on the reward information, the owner of the computer can get a return in exchange for the offering of the image data processing resource of the user's own computer.

Furthermore, the reward information producing means produces the reward information to give the reward of a charge to the owner of the computer that executes the processing of image data.

According to this configuration, if a charge for using the service, a communication rate, or the like, for example, of the owner of the computer that executed the processing of the image data is reduced based on the reward information, the owner can utilize the service at an inexpensive cost.

Furthermore, the reward information producing means decides contents of the reward information to give the reward of the charge, in response to an amount of image data processed by the computer that executes the processing of the image data.

According to this configuration, for example, if the reward information for enhancing a reduction rate of the charge for using the service as an amount of processed image data is increased by the computer that executed the processing of the image data is produced, an increase in the service utilization can be expected.

### BRIEF DESCRIPTION OF THE DRAWINGS

FIG. 1 is a view showing a schematic configuration of an image processing service system 10 to explain a first embodiment of the present invention;

FIG. 2 is a view showing an operational flowchart of an image processing server in the image processing service system to explain the first embodiment of the present invention;

FIG. 3 is a view showing a schematic configuration of an image processing service system 20 to explain a second embodiment of the present invention;

FIG. 4 is a view showing contents of data registered with a user's information database of an image processing server in the image processing service system to explain the second embodiment of the present invention; and

FIG. 5 is a view showing an operational flowchart of an image processing server in the image processing service system to explain the second embodiment of the present invention.

### DETAILED DESCRIPTION OF THE PREFERRED EMBODIMENTS

(First Embodiment)

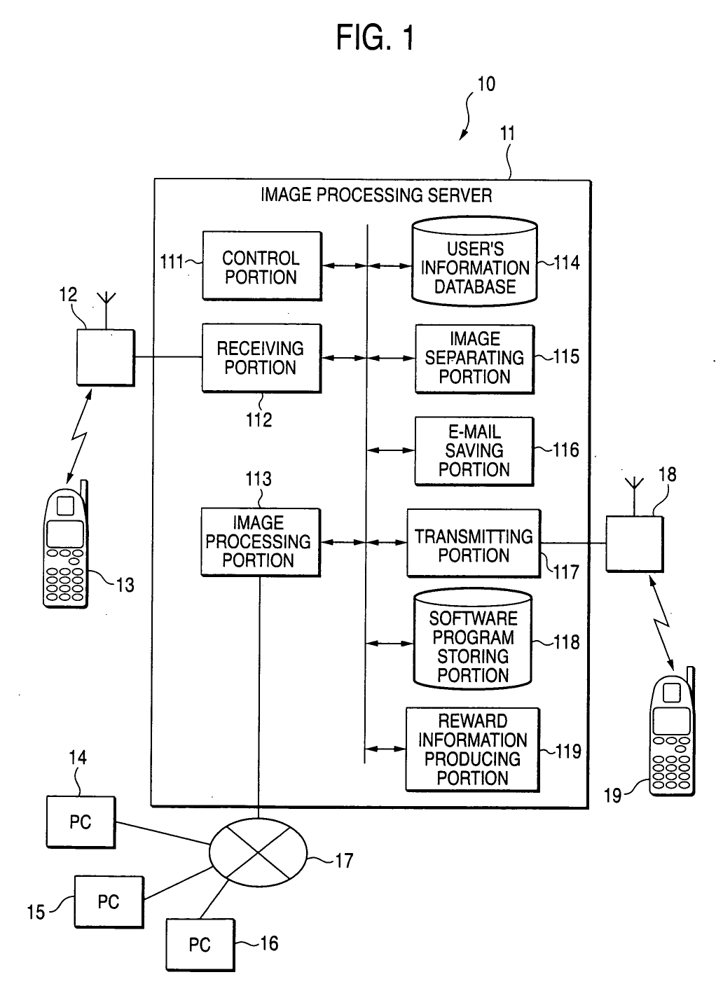

FIG. 1 is a view showing a schematic configuration of an image processing service system 10 to explain a first embodiment of the present invention. An image processing service system 10 has base stations 12, 18 for relaying a communication between cellular phones 13 and 19, an image processing server 11 connected between the base station 12 and the base station 18 via the radio or the cable, and a plurality of PCs (personal computers) 14, 15 and 16 which are always connected to the image processing server 11 via a network 17 through ADSL, CATV, optical fiber, or the like. The image processing server 11 may be built in the base station 12 or 18.

A plurality of PCs 14 to 16 is owned by users who are registered with the image processing service system 10. These PCs 14 to 16 executes the processing of the image data sent from the image processing server 11 by executing a software program distributed from the image processing server 11. The processing executed herein is white balance correction, gray-scale correction, sharpness correction, or the like of a photographic picture or a motion picture.

The image processing server 11 includes a control portion 111, a receiving portion 112, an image processing portion 113, a user's information database 114 which stores information about users who own the PCs 14 to 16, an image separating portion 115 which separates image data from an e-mail to which the image data are attached (referred to “e-mail” hereinafter), an e-mail saving portion 116 which saves the e-mail from which the image data are separated, a transmitting portion 117, a software program storing portion 118 which stores the software program, and a reward information producing portion 119 which produces reward information applied to give a reward to the users who are registered with the user's information database 114.

The control portion 111 controls respective portions. The receiving portion 112 receives the e-mail transmitted from the cellular phone 13 via the base station 12. The image separating portion 115 separates image data from the e-mail received by the receiving portion 112, supplies the image data to the image processing portion 113, and stores the e-mail, from which the image data was separated, to the e-mail saving portion 116.

The user's information database 114 stores identification information to identify the PCs 14 to 16 and user ID to identify the users of the PCs 14 to 16 in correspondence with each other. The identification information to identify the PCs 14 to 16 is, for example, IP addresses, etc. Information to be registered with the user's information database 114 are registered at the time when the users of the PCs 14 to 16 download a software program to be stored in the software program storing portion 118.

The image processing portion 113 executes the processing of image data supplied from the image separating portion 115 by utilizing a grid computing system that is constructed by a plurality of PCs 14 to 16 connected via the network 17. The grid computing system is a system in which a high-performance computer is virtually constructed by connecting a plurality of computers via a network to utilize necessary processing capability and storage capacity from respective PCs.

More particularly, the image processing portion 113 identifies PCs, in which a CPU operating ratio is lower than a predetermined value, out of the PCs registered with the user's information database 114, then divides the image data supplied from the image separating portion 115 into plural pieces, transmits the divided image data to the identified PC so as to provide an instruction for the processing of the divided image data. In addition, the image processing portion 113 acquires image data processed by the PCs to synthesize them, and then supplies the synthesized image data to the transmitting portion 117. The transmitting portion 117 attaches the synthesized image data, which was supplied from the image processing portion 113, to the e-mail saved in the e-mail saving portion 116, and then transmits an e-mail with the synthesized image to the cellular phone 19 as the destination via the base station 18.

The reward information producing portion 119 produces reward information used to give some reward to the users of the PCs that executed the processing of image data by indicated from the image processing portion 113. Then, the reward information producing portion 119 stores the reward information in the user's information database 114 in correspondence with user IDs stored in the user's information database 114. The reward information is numerical information indicating point, for example.

The manager of the image processing server 11 periodically checks an amount of points corresponding to the user ID in the user's information database 114, and then gives any reward with regard to the charges to the user according to the amount of points. The reward are, for example, discount of the communication charge of the cellular phone that the user holds, discount of the charge of the image processing service for the user, partial share in heat and light expense for the user, etc. The reward information producing portion 119 decides the number of points according to the volume of processed image data. For example, the reward information producing portion 119 increases the number of points if the volume of processed image data is large, and decreases the number of point if the volume of processed image data is small.

The reward information producing portion 119 records the point every time when a PC executes the processing of image data. In contrast, the cumulative volume of processed data of every user may be accumulate stored every time when a PC executes the processing of image data, then the number of points may be decided according to the cumulative volume of processed data after a predetermined period has passed be recorded in the user's information database 114.

An operation of the image processing server 11 of the image processing service system 10 shown in FIG. 1 will be explained hereunder. Here, en example that the processing of image data attached to the e-mail transmitted from the cellular phone 13 is executed by the PC 14 and the PC 15 will be explained hereunder.

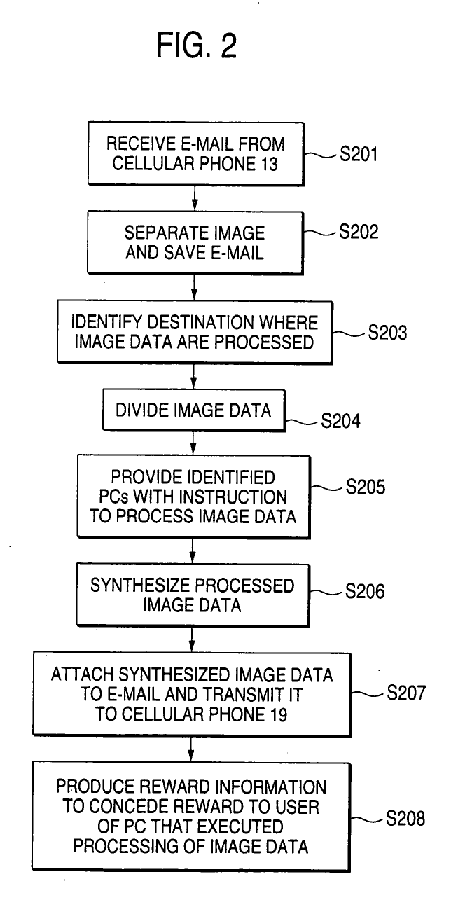

FIG. 2 is a view showing an operational flowchart of the image processing server in the image processing service system to explain the first embodiment of the present invention.

The image processing server 11 receive an e-mail from the cellular phone 13 (S201), and then separates image data from the received e-mail to save an e-mail from which the image data are separated (S202). Then, the image processing server 11 identifies the PCs 14 and 15 that are requested to process the image data (S203), then divides the image data into two parts (S204), and then transmits each of the divided image data to the PCs 14, 15 in accordance with the IP addresses recorded in the user's information database 114 and then provides the identified PCs with the instruction to process the image data (S205).

The image processing server 11 receives two image data processed by the PCs 14, 15 and synthesize two received image data (S206), and then attach the synthesized image data to the e-mail saved in step S202 and transmits the e-mail to the cellular phone 19 as the destination (S207). After the transmission of the e-mail, the image processing server 11 produces point information as the reward information to give the reward to users of the PCs 14, 15 that executed the processing of the divided image data (S208), and then updates the point information of the users of the PCs 14, 15 in the user's information database 114.

As described above, according to the present embodiment, the image processing server 11 causes the PCs 14, 15 connected via the network 17 to process the image data attached to the e-mail transmitted from the cellular phone 13. Therefore, even if a high volume of image data are transmitted, the image processing server 11 can distribute the processing of the image data and avoid an halt. Also, since the image processing server 11 does not need to have means for processing the image, a working cost of the image processing server 11 can be reduced.

Also, the reward such as discount of the ADSL charge, partial share in the heat and light expense, or the like is given to the users who are registered with the image processing service system 10 and provide the PC as the resource for processing the image data. Therefore, not only the user provides the resource one-sidedly but also the user can get a return. As a result, it is expected that the number of users registered with the image processing service system 10 is increased, and thus the manager side of the image processing service can provide the service to execute the higher-speed image processing.

In this manner, the manager side of the image processing service can provide the good-quality service at a low cost, while the users who cooperate with the manager side of the service can get the reward by merely providing the user's own PC. Therefore, the system that is advantageous to both sides can be implemented.

In this case, the example in which the e-mail is transmitted from the cellular phone 13 is explained in the present embodiment. However, even though the image data are transmitted from the computer connected to the network 17, or the like, the similar processing can be applied.

(Second Embodiment)

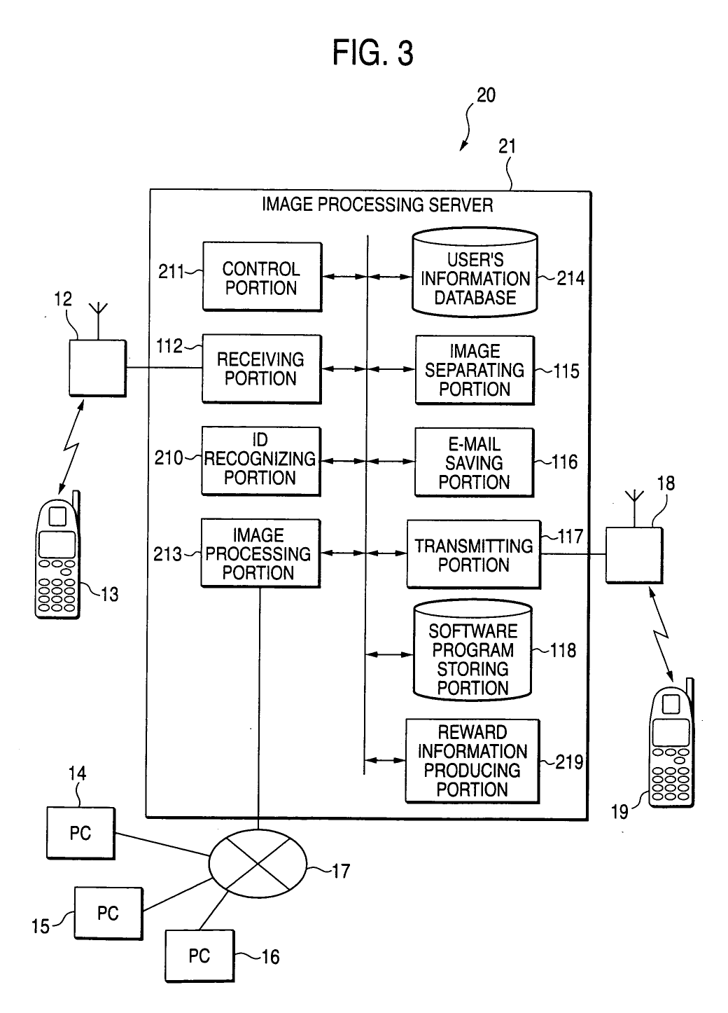

FIG. 3 is a view showing a schematic configuration of an image processing service system 20 to explain a second embodiment of the present invention. Explanation will be made by affixing the same symbols to the same configurations as those in FIG. 1.

An image processing server 21 of the image processing service system 20 has a control portion 211, a receiving portion 112, an ID recognizing portion 210, an image processing portion 213, a user's information database 214, an image separating portion 115, an e-mail saving portion 116, a transmitting portion 117, a software program storing portion 118, and a reward information producing portion 219.

The control portion 211 controls respective portions. The ID recognizing portion 210 recognizes identification information such as the phone number, the E-mail address, or the like of the cellular phone 13 to identify the cellular phone 13, based on the e-mail being received by the receiving portion 112.

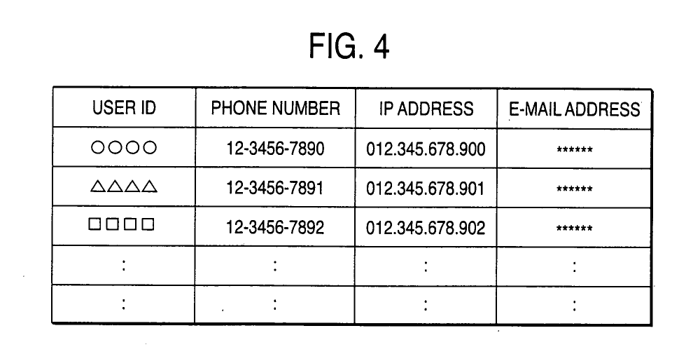

The user's information database 214 stores the identification information to identify the PCs 14 to 16 and identification information to identify the cellular phones that the users of the PCs 14 to 16 have in correspondence with each other. FIG. 4 is a view showing contents of data that are registered with the user's information database of the image processing server in the image processing service system to explain the second embodiment of the present invention. As shown in FIG. 4, the user ID used to identify the user, the phone number and the E-mail address as the identification information of the cellular phone that the user has, and IP address as the identification information of the PC that the user has are registered with the user's information database 214. The information shown in FIG. 4 are registered at the time when the users of the PCs 14 to 16 download a software program to be stored in the software program storing portion 118.

The image processing portion 213 identifies a PC owned by a user of the cellular phone 13, based on the identification information of the cellular phone 13 recognized by the ID recognizing portion 210, and the user's information database 214, then transmits the image data supplied from the image separating portion 115 to the identified PC, and then provides the identified PC with the instruction to process the image data. Also, the image processing portion 213 receives the processed image data, and supplies such processed image data to the transmitting portion 117.

The reward information producing portion 219 produces the reward information to give the reward to the user of the PC that was instructed by the image processing portion 213 to execute the processing of the image data, then stores this information in the user's information database 214 in correspondence with the user ID in the user's information database 214. Since the concrete processings are similar to those in the reward information producing portion 119 shown in FIG. 1 in the first embodiment, their explanation will be omitted herein.

The manager of the image processing server 21 periodically checks an amount of points corresponding to the user ID in the user's information database 214, and then gives any reward with regard to the charge to the user according to the amount of points. The reward are, for example, partial share in the charge for the provider that the PC of the user employs, discount of the communication charge of the cellular phone that the user holds, discount of the charge of the image processing service for the user, partial share in user's heat and light expense, etc.

An operation of the image processing server 21 of the image processing service system 20 shown in FIG. 3 will be explained hereunder. Here, an example in which the PC 14 registered with the present system is owned by the user of the cellular phone 13 used to transmit the e-mail will be explained hereunder.

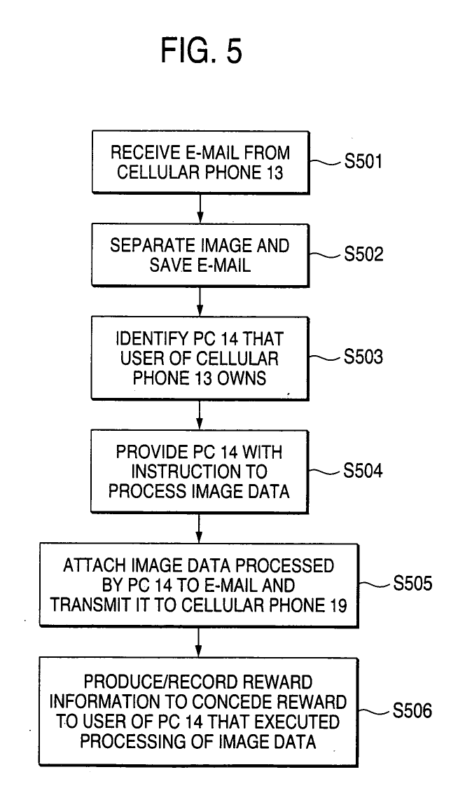

FIG. 5 is a view showing an operational flowchart of the image processing server in the image processing service system to explain the second embodiment of the present invention.

The image processing server 21 receives an e-mail from the cellular phone 13 (S501), and then separates image data from the received e-mail to save an e-mail from which the image data are separated (S502). Then, the image processing server 21 recognizes the e-mail address of the cellular phone 13 as the sender of the e-mail, and then identifies the PC that the user of the cellular phone 13 holds (here, the PC 14) based on the recognized e-mail address and the user's information database 214 (S503). Then, the image processing server 21 transmits the image data to the PC 14 based on the IP address of the PC 14 recorded in the user's information database 214, and then provides the PC 14 the instruction to process the image data (S504).

The image processing server 21 receives the image data processed by the PC 14, then attaches the received image data to the e-mail saved in step S502 and transmits the e-mail to the cellular phone 19 as the destination (S505). After the transmission of the e-mail, the image processing server 21 produces point information as the reward information to give the reward to user of the PC 14 that executed the processing of the image data (S506), and then updates the point information of the user of the PC 14 in the user's information database 214.

As described above, according to the present embodiment, the image processing server 21 can cause the PC 14 that is owned by the user of the cellular phone 13 to execute the processing of the image data received from the cellular phone 13. Therefore, the necessary facilities for the processing of the image data can be reduced and a working cost of the image processing server can be reduced. In the grid computing system of the first embodiment in which the distributed processing is executed by linking a plurality of PCs that exist on the network, the image processing server must select the PC according to its working condition for the processing. In contrast, in the present embodiment, the image processing server 21 can easily decide the PC, which is to be instructed to process the image data, according to the e-mail address of the cellular phone that transmits the e-mail. Therefore, its processing load can be reduced.

Further, since the image data are not processed by the PC of another person except the user, the user of the cellular phone 13 and the PC 14 can protect user's privacy. Also, the reward such as discount of the ADSL charge, partial share in the heat and light expense, or the like is given to the PC user who executed the processing of the image data. Therefore, not only the user provides the resource one-sidedly but also the user can get a return. As a result, it is expected that the number of users registered with the image processing service system 20 is increased, and thus the manager side of the image processing service can provide the service to execute the higher-speed image processing.

In this manner, the manager side of the image processing service can provide the good-quality and high-safety service at a low cost, while the users who cooperate with the manager side of the service can get the reward by merely providing the user's own PC. Therefore, the system that is advantageous to both sides can be implemented.

In step S505 of FIG. 5, when a power supply of the PC 14 that is owned by the user of the cellular phone 13 is not turned ON, the image processing portion 213 of the image processing server 21 may execute the processing of the image data. Also, as the reward offered to the user, some gift may be presented to the user in addition to the reward of the charge for the user.

According to the above embodiments, the image processing server 11, 21 that are capable of implementing the service to execute the processing of image data at a low cost can be provided.

What is claimed is:

1. An image processing server, which provides a service to execute processing of image data, comprising:
image processing means for processing image data received from a terminal device by utilizing a grid computing; and
reward information producing means for producing reward information to give a reward to an owner of a computer, which executes the processing of image data, out of computers that constitute the grid computing.

2. An image processing server, which provides a service to execute processing of image data received from a mobile terminal device, comprising:
identifying means for identifying a computer owned by an owner of a mobile terminal device, based on a database stores first identification information to identify a computer, which is connected to the image processing server through network, for executing the processing of image data in response to an instruction by the image processing server and second identification information to identify a mobile terminal device owned by an owner of the computer in correspondence with each other, and third identification information to identify a mobile terminal device which sends image data; and
image processing instructing means for providing the computer identified by the identifying means with an instruction to execute the processing of image data.

3. The image processing server according to claim 2, further comprising:
reward information producing means for producing reward information to give a reward to an owner of a computer which executes the processing of image data.

4. The image processing server according to claim 1, wherein the reward information producing means produces the reward information to give the reward of a charge to the owner of the computer that executes the processing of image data.

5. The image processing server according to claim 4, wherein the reward information producing means decides contents of the reward information to give the reward of the charge, in response to an amount of image data processed by the computer that executes the processing of the image data.

6. The image processing server according to claim 3, wherein the reward information producing means produces the reward information to give the reward of a charge to the owner of the computer that executes the processing of image data.

7. The image processing server according to claim 6, wherein the reward information producing means decides contents of the reward information to give the reward of the charge, in response to an amount of image data processed by the computer that executes the processing of the image data.

8. An image processing server, which provides a service to execute processing of image data, comprising:
an image processing portion which processes image data received from a terminal device by utilizing a grid computing; and
a reward information producing portion which produces reward information to give a reward to an owner of a computer, which executes the processing of image data, out of computers that constitute the grid computing.

9. An image processing server, which provides a service to execute processing of image data received from a mobile terminal device, comprising:
an identifying portion which identifies a computer owned by an owner of a mobile terminal device, based on a database stores first identification information to identify a computer, which is connected to the image processing server through network, for executing the processing of image data in response to an instruction by the image processing server and second identification information to identify a mobile terminal device owned by an owner of the computer in correspondence with each other, and third identification information to identify a mobile terminal device which sends image data; and
an image processing instructing portion which provides the computer identified by the identifying portion with an instruction to execute the processing of image data.

10. The image processing server according to claim 9, further comprising:
a reward information producing portion which produces reward information to give a reward to an owner of a computer which executes the processing of image data.

11. The image processing server according to claim 8, wherein the reward information producing portion produces the reward information to give the reward of a charge to the owner of the computer that executes the processing of image data.

12. The image processing server according to claim 11, wherein the reward information producing portion decides contents of the reward information to give the reward of the charge, in response to an amount of image data processed by the computer that executes the processing of the image data.

13. The image processing server according to claim 10, wherein the reward information producing portion produces the reward information to give the reward of a charge to the owner of the computer that executes the processing of image data.

14. The image processing server according to claim 13, wherein the reward information producing portion decides contents of the reward information to give the reward of the charge, in response to an amount of image data processed by the computer that executes the processing of the image data.
